(19) United States
(12) Patent Application Publication
(10) Pub. No.: US 2011/0245452 A1
(43) Pub. Date: Oct. 6, 2011

(54) Integrated Underwater Melt Cutting, Solid-State Polymerization Process

(75) Inventor: Constantin Ionita, Antwerp (BE)

(73) Assignee: UOP LLC, Des Plaines, IL (US)

(21) Appl. No.: 12/751,040

(22) Filed: Mar. 31, 2010

(51) Int. Cl. C08G 63/80

(52) U.S. Cl. 528/308.1

(57) ABSTRACT

Methods for solid-state polymerization (SSP) and more particularly to providing partially crystallized polyester resin, or prepolymer, to an SSP reactor using underwater melt cutting are disclosed. The methods are preferably integrated with nitrogen purification of the SSP reactor effluent to provide nitrogen streams for stripping and/or preheating of pellets from underwater melt cutting.

### FIELD OF THE INVENTION

The present invention relates to solid-state polymerization (SSP) processes for the production of polyesters having commercially desirable properties in terms of molecular weight (related to intrinsic viscosity), acetaldehyde content, and other characteristics. Underwater melt cutting is used to form particles of polyester prepolymer that are partially crystallized prior to being fed to the downstream SSP reactor.

### DESCRIPTION OF RELATED ART

Polymer resins, and particularly polyesters, are molded into a variety of useful products. Representative aromatic polyesters having significant commercial applications include polyethylene terephthalate (PET), polytrimethylene terephthalate (PTT), polybutylene terephthalate (PBT), polytrimethylene naphthalate (PTN), polycyclohexyl terephthalate (PCT) and polyethylene naphthalate (PEN). Of these polyester resins, PET, copolymers of terephthalic acid with lower proportions of isophthalic acid, and PBT are currently widely used in the production of beverage containers, films, fibers, packages, and tire cord.

Commercial processes for manufacturing polyesters typically include four steps: esterification, precondensation, finishing, and solid-state polymerization (or solid-state polycondensation) (SSP). The conventional melt-phase polymerization (MPP) process for manufacturing PET chips comprises the first three of these steps. The finishing step in MPP continues to upgrade the molten polyester (e.g., PET) to higher molecular weights, appropriate for fiber grades and bottle pre-polymers. During the finishing step, the highly viscous molten polyester is continuously stirred with a specially-designed agitator to increase its surface area for effective removal of ethylene glycol (EG) and other byproducts by using a very low vacuum or forcing an inert gas through the reaction mixture. Although the finishing step advances the polymer resin molecular weight, further upgrading of the MPP product is still necessary for some important commercial uses. Upgrading is normally achieved in subsequent processing by forming the MPP product into particles and subjecting them to SSP. Molecular weight is increased in SSP by maintaining the solid polymer particles at temperatures between the glass transition and melting point temperatures, while removing the reaction products under an inert gas sweep or vacuum.

In a typical SSP process, molten polyester resin from the MPP is cooled and then formed into pellets or pastilles as prepolymers. This can be accomplished by extrusion of the amorphous MPP product into strands under pressure and cutting of the extruded material into smaller particles, followed by rapid quenching. Clear, amorphous pellets may be made from this extrusion or, in a modified MPP process without the finishing step, opaque, partially crystalline pellets may be generated. In the latter case, however, the partially crystalline prepolymers have a relatively low intrinsic viscosity (IV), for example between 0.50 dl/g (0.80 ft³/lb) and 0.70 dl/g (1.1 ft³/lb). In contrast, the manufacturing of commercial beverage bottles, tire cord, industrial yarn, and other useful products requires processing (e.g., by injection molding, stretched blow molding, spinning, etc.) of PET chips with IV of about 0.70 dl/g (1.1 ft³/lb) to about 1.2 dl/g (1.92 ft³/lb). Therefore, whether the prepolymers from MPP are amorphous or partially crystalline, they must be fed to a subsequent SSP reactor to increase their molecular weight, and consequently their IV, for bottle production and other applications.

In the SSP reactor, the mechanisms for polymer growth are ester interchange (or polycondensation), which eliminates ethylene glycol, and esterification, which eliminates water, with both of these reactions being reversible and equilibrium limited. An inert gas stream, typically nitrogen, is passed through the SSP reactor to heat the PET particles, purge the ethylene glycol, water, and other byproducts, and prevent degradation of the polymer at elevated temperatures. Purge of byproducts helps drive the reaction equilibrium toward the desired chain growth condensation reactions. The inert gas environment is also important for reducing side reactions, including thermal and catalytic degradation of the polymer that lowers its quality. Major side reactions of concern are those leading to the formation of acetaldehyde, through, for example, polycondensation of vinylester end groups. The SSP reactor effluent gas is normally purified and recycled to the SSP reactor. An important aspect of the SSP reactor is control of the acetaldehyde content of the polymer. The acetaldehyde byproducts are vaporized, diffuse out of the polymer when heated, and are purged away by the inert gas stream during SSP.

Overall, therefore, SSP is a thermal treatment process to upgrade polyester prepolymer resins (e.g., PET resin) to a desired molecular weight, which is related to IV. The SSP reactor is typically a gravity-driven, moving bed system. Polyester prepolymers release significant exothermic heat of crystallization if not crystallized to a sufficient degree. The continuance of crystallization to any appreciable extent in the SSP reactor leads to problems of heat release and agglomeration or sintering of the polymer particles, causing maldistribution of gases and flow interruptions of solids. Moreover, non-crystallized or amorphous pellets of prepolymer fed to this reactor are not thermally stable, and therefore become sticky, above the glass transition temperature (T_{g}). In the case of PET, the value of T_{g} is of about 70° C. (158° F.), while the SSP reaction temperature is above 190° C. (374° F.). Consequently, it is a prerequisite that the prepolymer from MPP is at least partially crystallized prior to being fed to the SSP reactor. With partially crystallized pellets, the potential for stickiness shifts from the glass transition temperature toward the onset of melting, which is about 245° C. (473° F.) for PET polymerization reaction systems.

For example, U.S. Pat. No. 4,064,112 teaches that the tendency of prepolymer particles to agglomerate due to stickiness during SSP can be reduced or even eliminated if SSP is preceded by a crystallization step that comprises a thermal treatment. A process described in U.S. Pat. No. 5,540,868 forms low molecular weight polyester particles with a degree of crystallinity greater than about 15% suitable for use as an SSP feedstock. U.S. Pat. No. 5,290,913 discloses crystallizing PET particles in an agitated liquid bath and heating to crystallization temperature. U.S. Pat. No. 5,532,335 and WO 00/23497 teach crystallizing polyesters in liquid over 100° C. (212° F.). Processes described in U.S. Pat. No. 6,740,733, U.S. Pat. No. 6,297,315, and U.S. Pat. No. 6,461,575 separate relatively cool water used in pelletizing from PTT pellets and crystallize these pellets in relatively warm water at no more than 100° C. (212° F.). WO 00/23497 discloses cooling PET during or after forming and then crystallizing PET pellets at above 100° C. (212° F.).

U.S. Pat. No. 6,749,821 teaches that in a typical SSP process, polymer particles are delivered to an SSP reactor system through a hopper to a heated, fluidized bed pre-crystallizer operating to achieve a degree of crystallinity. The polymer particles are fed into a first crystallizer and then optionally into a second crystallizer. The crystallizers heat the polymer particles under mechanical agitation to bring them to the desired reaction temperature and degree of crystallinity suitable for the ensuing SSP reactor. It is therefore evident from these disclosures and others that precrystallizer and crystallizer vessels are typically utilized between the MPP process and the conventional SSP reactor. The inlet of the tall SSP reactor is high above the ground, such that the prepolymer particles must be lifted to enter this reactor. In industrial practice, this is usually achieved by slow motion pneumatic conveying. In the case of using a precrystallizer, crystallizer, and SSP reactor in series, the elevation of the entire complex is very high in the normal case in which these operations are conducted in a stacked arrangement.

The precrystallization and/or crystallization steps add to the complexity, space requirements, and consequently the overall costs of the SSP process. This is particularly evident with respect to the consumption of utilities such as electricity for heating amorphous polyester supplied from MPP and operating the conventional paddle crystallizers that require a hot oil heat transfer medium and rotating equipment used to provide mechanical agitation. Efforts to simplify SSP processes, without sacrificing the polyester product quality in terms of its IV and other commercially important properties, are therefore ongoing.

### SUMMARY OF THE INVENTION

The present invention is associated with the discovery of important advantages resulting from the use of underwater melt cutting in solid-state polymerization (SSP) processes that are integrated with nitrogen purification systems. Benefits of the processes can include a reduction in investment cost and/or utility consumption per ton of PET produced at a given intrinsic viscosity (IV) with a given quality of PET supplied from melt-phase polymerization (MPP). Purification of nitrogen in the nitrogen-containing SSP reactor effluent gas, via catalytic combustion of acetaldehyde and other hydrocarbon impurities that are swept from the reaction environment, is advantageously integrated with stripping and/or preheating zones, following underwater melt cutting that imparts significant crystallinity to the prepolymer fed to the SSP reactor. This integration reduces or even completely eliminates detrimental emissions of organic compounds that are contained in process effluents from conventional processes, for example the outlet air used for drying of the cut MPP product.

Underwater melt cutting has been found to provide a number of desirable features in integrated SSP processes described herein. For example, the formation of polyester (e.g., PET) pellets, as prepolymer, using this technique beneficially crystallizes the MPP product to an extent such that precrystallization and/or crystallization requirements upstream of the SSP reactor can be significantly decreased or obviated altogether. The removal of a crystallizer saves costs of not only the vessel and its rotating internal parts, but also the associated equipment such as hot oil pumps as well as the associated utilities for the significant heating and mechanical agitation requirements. It is estimated, for example, that electricity and heat consumption may be reduced by 10% and 40%, respectively, as a result of eliminating the conventional upstream crystallizer(s) in the overall SSP process. Equipment space is also beneficially conserved.

Moreover, pellets from underwater melt cutting may be advantageously conveyed directly to the SSP reactor at an elevated temperature, for example about 160° C. (320° F.) to about 215° C. (419° F.) with a crystallinity of at least about 35%. In contrast, amorphous polyester cylindrical pellets, made conventionally by strand cutting of MPP product, are normally cooled down to about 60° C. (140° F.) and fed to and from storage prior to being conveyed to the SSP process.

In addition to imparting crystallinity, a number of other important advantages result from the underwater melt cutting process, in terms of the characteristics of the pellets formed, typically as rounded “chips” rather than cylinders. The egg-shaped or spherical chips (having an oval or circular cross section) are beneficially resistant to attrition, compared to cylinders having hard-edged contact points, as conventionally formed with strand cutting. Raw material consumption is thereby reduced. Unlike cylindrical extrudates, the lack of edges in the shapes produced from underwater melt cutting result in a higher bulk density, as a result of more efficient packing/reduced void volume.

These and other aspects and features relating to the present invention are apparent from the following Detailed Description.

### BRIEF DESCRIPTION OF THE DRAWINGS

FIG. 1 depicts an integrated solid-state polymerization (SSP) process, according to a representative embodiment of the invention.

FIG. 1 is to be understood to present an illustration of the invention and/or principles involved. Details including pumps, blowers, heat exchangers, filters, instrumentation, and other items not essential to the understanding of the invention are not shown. As is readily apparent to one of skill in the art having knowledge of the present disclosure, SSP processes and particularly those that are integrated with underwater melt cutting and nitrogen purification operations as described herein, according to various other embodiments of the invention, will have configurations and components determined, in part, by their specific use.

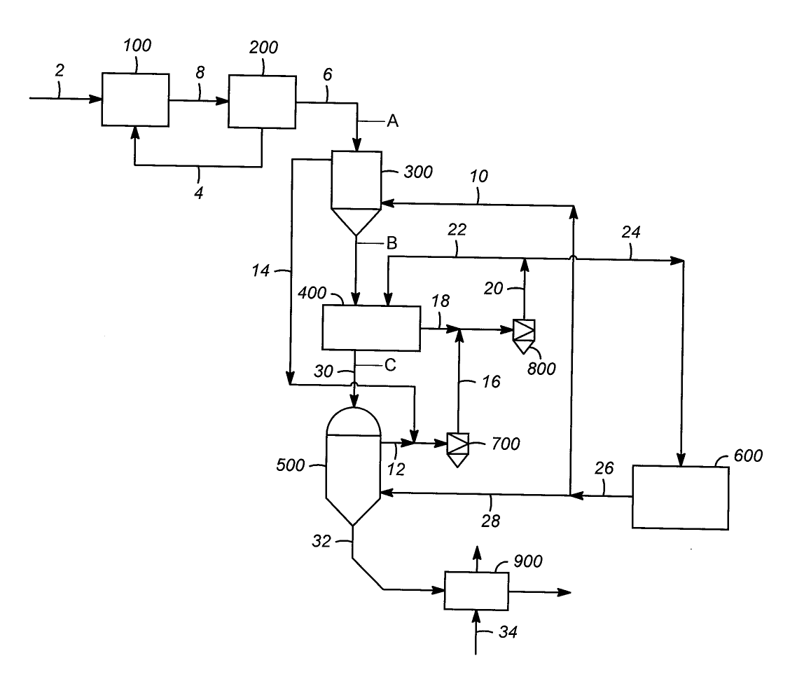

### DETAILED DESCRIPTION

The present invention generally relates to methods for solid-state polymerization (SSP) and more particularly to providing partially crystallized polyester resin, or prepolymer, to an SSP reactor using underwater melt cutting. The methods are preferably integrated with nitrogen purification to achieve one or more of the advantages discussed above. The prepolymer that is provided according to these methods may then be contacted countercurrently with upwardly flowing nitrogen carrier gas in an SSP reactor to provide a polyester product and a nitrogen-containing effluent from the SSP reactor that is processed in the nitrogen purification unit to remove organic materials and water. As noted, some crystallization of the prepolymer is necessary to avoid problems in the SSP reactor due to excessive polymer sticking and/or release of substantial crystallization heat. The methods are applicable for upgrading a wide range of polyester resins, for example any of those selected from polyethylene terephthalate (PET), polytrimethylene terephthalate (PTT), polybutylene terephthalate (PBT), polytrimethylene naphthalate (PTN), polycyclohexyl terephthalate (PCT) and polyethylene naphthalate (PEN). PET is of particular interest in these processes.

Representative methods comprise contacting a molten, melt-phase polymerization (MPP) product, namely a polyester resin, with an aqueous liquid and cutting it into pellets, preferably having shapes that lack edges and thereby resist attrition. Typical underwater pelletizing systems, for example, utilize a cutting chamber that is filled with water or another aqueous liquid (e.g., recycled water comprising low levels of dissolved and/or suspended contaminants from the MPP product). Underwater pelletizers generally cut the MPP product in the aqueous environment immediately upon passing through an extrusion die plate. Due to the high temperature difference between the melt and water, the cut polymer drops solidify quickly into characteristic spherical or egg-shaped forms characteristic of the underwater cutting operation. The cut pellets typically have a maximum dimension (e.g., diameter of a sphere, major axis of the largest elliptical cross section, or other largest dimension) from about 1 mm (0.04 inches) to about 5 mm (0.20 inches). Underwater pelletizing systems are available commercially, for example, from BKG Bruckmann & Kreyenborg Granuliertechnik GmbH (Münster, Germany). As discussed above, the shape of the pellets obtained from underwater melt cutting can beneficially reduce solid polyester attrition and dust formation in downstream processing operations including stripping and preheating/fluidization upstream of the SSP reactor. For example, dust generation may be reduced as much as 40% or more relative to processes using conventional strand cutting for the formation of cylindrical pellets.

Following cutting/forming of the MPP resin product into pellets, while submerged in the aqueous liquid used for underwater melt cutting, as discussed above, representative methods further comprise drying the cut pellets. A drying zone comprising, for example, a centrifugal drier or other type of drier may be used to separate dried pellets from the aqueous liquid used in underwater melt cutting. At least a portion of the aqueous liquid is normally recycled and again contacted with the molten MPP product in the underwater melt cutting. A purge stream exiting the recycle loop may be used to limit the accumulation of impurities in the aqueous liquid, in combination with a fresh makeup feed of aqueous liquid (e.g., pure water) to the recycle loop.

Advantageously, integration with a nitrogen purification unit is accomplished by contacting the dried pellets with a feed gas comprising at least a portion of a nitrogen-containing effluent gas from the downstream SSP reactor, optionally after removal of organic compounds (e.g., using catalytic combustion in the presence of a precious metal catalyst) and water (e.g., using molecular sieve dryers) from the nitrogen-containing effluent gas (or effluent gas portion). The nitrogen-containing effluent gas, or portion thereof, can be used beneficially for various purposes in conjunction with melt cutting to provide partially crystallized polyester resin according to methods described herein. The gas may be used, for example, for stripping impurities such as acetaldehyde and/or dust from the dried pellets. Heating of the nitrogen-containing effluent gas, or a portion thereof, prior to contacting it with dried pellets can also provide a heating function, for example by preheating the pellets prior to their use in the SSP reactor, in addition to stripping and/or drying functions.

An illustrative embodiment of an SSP process, in which partially crystallized polyester resin is provided to an SSP reactor according to integrated methods described herein, is shown in the FIGURE. According to this particular embodiment, molten MPP product 2 (e.g., melt-phase polyethylene terephthalate (PET) product) is usually amorphous or has an average crystallinity of less than about 10%. The percent crystallinity may be based on the density of a representative sample, or otherwise a representative number of pellets, by its/their buoyancy in a gradient density column according to ASTM D1505-98, “Standard Test Method for the Density of Plastics by Density-Gradient Technique,” assuming density values corresponding to 0% (completely amorphous) and 100% (completely crystalline) crystallinity. In the case of PET, for example, these values are 1.332 g/cc (83.08 lb/ft³) and 1.455 g/cc, (90.75 lb/ft³) respectively. The MPP product, if PET is used, also has an intrinsic viscosity (IV) generally from about 0.50 dl/g (0.80 ft³/lb) to about 0.70 dl/g (1.1 ft³/lb) which, although adequate for textile or carpet applications, must be significantly increased by advancing its molecular weight for other applications including commercial beverage bottles. The manufacture of major commercial polyester (e.g., PET) end products such as bottles, tire cord, and industrial yarn, requires processing by various techniques such as injection molding, stretched blow molding, and spinning of chips, often having an IV of about 0.70 dl/g (1.1 ft³/lb) to about 1.2 dl/g (1.92 ft³/lb).

According to the embodiment depicted in the FIGURE, MPP product 2 is generally provided at an elevated temperature, for example in the case of PET resin in the range from about 230° C. (446° F.) to about 290° C. (554° F.), to underwater cutting zone 100, which may comprise booster pumps (not shown) and other equipment peripheral to an underwater cutting device, such as an underwater pelletizer discussed above. Cutting of MPP product 2 occurs by contacting it with a hot aqueous liquid (e.g., substantially pure water) having a temperature generally in the range from about 60° C. (140° F.) to about 90° C. (194° F.). All or most of this hot aqueous liquid is aqueous recycle liquid 4 that is separated from dried pellets 6 in drying zone 200, which may comprise, for example, a centrifugal drier. The cut pellet/water mixture 8 from underwater cutting zone 100 is therefore fed to drying zone 200 to carry out this aqueous liquid separation or drying. The recycle loop defined by aqueous recycle liquid 4 will normally include associated equipment, generally at least a pump, a filter, and a heater (not shown), as well as makeup water and purge streams (not shown).

Dried pellets 6 are then fed to successive stripping and preheating zones 300, 400, each of which is fed by feed gases comprising at least a portion of nitrogen-containing effluent 12 from the downstream SSP reactor 500. For example, dried pellets 6 may be first contacted in stripping zone 300 with stripping zone feed gas 10 comprising a first portion of nitrogen-containing effluent 12 from SSP reactor 500 after removal of organic compounds in nitrogen purification unit (NPU) 600. In the specific embodiment shown in the FIGURE, nitrogen-containing effluent gas 12 from SSP reactor 500 is combined with preheating zone effluent gas 14, and the combined SSP reactor effluent/preheating zone effluent gas 16, is passed through first cyclone 700 to remove particulate matter (e.g., dust). Combined SSP reactor effluent/preheating zone effluent gas 16 is then introduced into a gas recycle loop, into and out of preheating zone 400. This gas recycle loop is formed by stripping zone effluent gas 18, the combined stripping zone effluent/SSP reactor effluent/preheating zone effluent gas 20, which is passed through second cyclone 800 to remove particulate matter (e.g., dust), and preheating zone feed gas 22.

In a preferred embodiment, this circulating recycle loop of hot gas through preheating zone 400 serves to fluidize dried pellets entering this zone at point B. The preheating zone 400 in this case serves as a dual preheating/fluidization zone with hot, upwardly flowing recycle gas contacting the dried pellets. The preheating zone in this case also beneficially performs a “dedusting” operation to help entrain dust particles, for example having a diameter of less than about 300 microns, which are then removed using second cyclone 800. In general, first and second cyclones 700, 800, depending on the desired size of particles removed and removal efficiency, may be replaced with other particulate removal systems such as filters, electrostatic devices, and combinations of devices.

A preheating zone gas purge 24 is removed from this gas recycle loop and sent to NPU 600 for combustion of organic compounds such as acetaldehyde (e.g., in the presence of a precious metal containing catalyst) and the removal of water using molecular sieve driers (not shown). Both preheating zone effluent gas 14 and stripping zone effluent gas 18 generally contain, in addition to acetaldehyde, ethylene glycol and water, such that treatment of preheating zone gas purge 24 in NPU 600 to combust organic materials and remove moisture is beneficial to the overall process.

Both stripping zone feed gas 10 and SSP reactor carrier gas 28 comprise portions of purified nitrogen 26 from NPU 600. In particular, stripping zone feed gas 10 comprises a first portion of nitrogen-containing effluent gas 12 from SSP reactor 500 after removal of organic compounds, namely the portion in combined stripping zone effluent/SSP reactor effluent/preheating zone effluent gas 20 that is in preheating zone gas purge 24 and that is subsequently purified in NPU 600 and not fed to SSP reactor 500 as SSP reactor carrier gas 28. Preheating zone feed gas 22 comprises a second portion of nitrogen-containing effluent gas 12 from SSP reactor 500, namely the portion in combined stripping zone effluent/SSP reactor effluent/preheating zone effluent gas 20 that is not in preheating zone gas purge 24 removed from the gas recycle loop around preheating zone 400. Preferably, organic compounds and water are removed using NPU 600, for example from stripping zone feed gas 10 that comprises a first portion of nitrogen-containing effluent gas 12 from SSP reactor 500. This stripping zone feed gas 10, as mentioned, is used to contact dried pellets in stripping zone 300.

The process according to the FIGURE therefore advantageously integrates NPU 600 for the purification of SSP reactor effluent 12 and effluents 14, 18 from stripping and preheating zones 300, 400, to minimize or eliminate the emission of organic byproducts in an overall SSP process. Moreover, underwater melt cutting zone 100 beneficially imparts substantial crystallinity to dried pellets 6, saving equipment and utility costs associated with conventional precrystallization and/or crystallization upstream of SSP reactor 500. Dried pellets 6 are therefore conveyed to subsequent stripping zone 300 and preheating zone 400, prior to molecular weight advancement, in SSP reactor 500, of the resulting partially crystallized polyester resin 30. Dried pellets 6 are beneficially maintained as a hot drying zone product at point A, a hot stripping zone product at point B, and a hot preheating zone product at point C, prior to entering SSP reactor 500. Maintaining the dried pellets at elevated temperature advantageously allows their transfer as hot material directly to SSP reactor 500, unlike in conventional processes in which amorphous pellets, produced by a strand cutter, are first cooled to generally a temperature of about 60° C. (140° F.), conveyed to storage, and then used in the SSP reactor. According to representative processes, therefore, there is no cooldown (e.g., to a temperature below about 60° C. (140° F.), or even below about 100° C. (212° F.)) of MPP product 2 as it is converted to dried pellets 6 after drying zone 200 at point A and subsequently to partially crystallized polyester resin 30 at point C, before SSP reactor 500. Dried pellets from preheating zone 400 at point C, corresponding to the partially crystallized polyester resin 30, are typically fed to SSP reactor 500 using a hot lift conveying system, thereby avoiding any cooldown in the integrated process until after SSP reactor 500.

In the case of PET resin, for example, the dried PET pellets from drying zone 200 at point A may have an average temperature generally from about 160° C. (320° F.) to about 210° C. (383° F.) upon contacting with the stripping zone feed gas 10, having a temperature generally from about 200° C. (392° F.) to about 235° C. (455° F.). This temperature range is also representative of that of preheating zone feed gas 22 used to contact, in preheating zone 400, dried pellets from stripping zone 300 at point B. Either or both of these gases can be maintained at a desired temperature, for example, using an electric heater (not shown) or other heating device such as a finned tube heat exchanger. Dried PET pellets from preheating zone 400 at point C, which are namely the partially crystallized polyester resin 30 provided to SSP reactor 500, have a temperature generally in the range from about 160° C. (320° F.) to about 215° C. (419° F.). The partially crystallized polyester resin 30, in the case of PET, at this point also has an average crystallinity of at least about 35%, and often in the range from about 35% to about 50%, such that it may be used as a polyester prepolymer for further upgrading, in terms of intrinsic viscosity and molecular weight advancement, in SSP reactor 500 without becoming sticky above the glass transition temperature (T_{g}). This level of crystallinity is also normally attained in the hot product from stripping zone 300 at point B. The partially crystallized polyester resin 30 is also typically in the form of pellets or chips having a maximum dimension, for example from about 1 mm (0.04 inches) to about 5 mm (0.20), as discussed above with respect to the pellets 6 from underwater melt cutting. The average bulk density of the pellets or chips is normally from about 0.8 g/cc (49.9 lb/ft³) to about 0.9 g/cc (56.1 lb/ft³).

Regardless of the particular polyester resin employed, the use of underwater melt cutting zone 100 to impart significant crystallinity reduces or preferably obviates the need for downstream precrystallizers and/or crystallizers, associated with conventional SSP processes. This can result in a significant reduction in utility consumption, for example resulting in an energy savings of about 40% relative to conventional processes, as well as capital (equipment) requirements. In a representative embodiment, for example, partially crystallized resin 30 is provided to SSP reactor 500 from its initial state as MPP product 2, without the use of mechanical agitators, including rotating devices such as screw conveyors, which are typically required in crystallizers. Such devices are therefore preferably absent in processes as described herein, from the melt cutting, drying, and stripping/preheating operations upstream of SSP reactor 500. Partially crystallized polyester resin 30 is fed to SSP reactor 500, and in a typical operation it flows downwardly to contact it countercurrently with upwardly flowing nitrogen carrier gas 28 to provide polyester product 32 and nitrogen-containing effluent 12 from SSP reactor 500.

In the embodiment depicted in the FIGURE, carrier gas 28 used to purge SSP reactor 500, comprises a portion of purified nitrogen 26, which generally contains no water as a result of drying (e.g., using molecular sieve driers). In the case of PET being used as the polyester, carrier gas 28 enters SSP reactor 500 at a temperature generally in the range from about 20° C. (68° F.) to about 80° C. (176° F.) and exits as nitrogen-containing effluent 12, containing volatile SSP reaction products such as acetaldehyde, ethylene glycol, and water, at a temperature generally in the range from about 195° C. (383° F.) to about 225° C. (427° F.). As discussed above, nitrogen-containing effluent 12 is then processed through cyclone 800 or other particulate removal device and sent to the recycle gas loop around preheating zone 400.

The purge of moisture generated in SSP reactor 500 and its elimination in NPU 600 serve to drive the equilibrium-limited polycondensation reactions in SSP reactor 500 further to completion, as necessary to advance polymer molecular weight. Polyester product 32 is normally in the form of polyester chips having an IV from about 0.70 dl/g (1.1 ft³/lb) to about 1.4 dl/g (2.2 ft³/lb), suitable for bottle, tire cord, and industrial yarn applications. Hot polyester product, in form of PET pellets or chips are discharged from SSP reactor 500, generally through further processing equipment such as a fluidized bed cooler/deduster 500 to cool and clean the polyester product 32 in the presence of flowing air 34.

In a specific embodiment, therefore, the present invention is a solid-state polymerization (SSP) process comprising (a) contacting a molten, melt-phase polymerization (MPP) product comprising polyethylene terephthalate (PET) having a crystallinity of less than about 10% with an aqueous liquid, wherein the molten MPP product has a temperature from about 230° C. (446° F.) to about 290° C. (554° F.) and the aqueous liquid has a temperature from about 60° C. (140° F.) to about 90° C. (194° F.) upon contacting; (b) cutting the MPP product, while submerged in the aqueous liquid, to form pellets; (c) separating dried pellets, formed from the MPP product, from the aqueous liquid in a drying zone and recycling a least a portion of the aqueous liquid to contact it with the molten MPP in step (a); (d) contacting the dried pellets from the drying zone, in a stripping zone with a first portion of a nitrogen-containing effluent gas from an SSP reactor after removing organic compounds by combustion, to provide a stripping zone effluent gas, wherein the dried pellets have an average temperature from about 160° C. (320° F.) to about 210° C. (410° F.) and the first portion of the nitrogen-containing effluent gas has a temperature from about 200° C. (392° F.) to about 235° C. (455° F.) upon contacting the dried pellets with the first portion of the nitrogen-containing effluent gas in the stripping zone; (e) contacting the dried pellets from the stripping zone, in a preheating zone with a second portion of the nitrogen-containing effluent gas from the SSP reactor, to provide a preheating zone effluent gas and a partially crystallized polyester resin having an average crystallinity of at least about 35%, wherein the second portion of the nitrogen-containing effluent has a temperature from about 200° C. (392° F.) to about 235° C. (455° F.) upon contacting it with the dried pellets in the preheating zone; and (f) flowing the partially crystallized polyester resin downwardly to contact it countercurrently, at an initial contacting temperature from about 160° C. (320° F.) to about 210° C. (410° F.), with upwardly flowing nitrogen carrier gas in the SSP reactor to provide a polyester product having an IV from about 0.70 dl/g (1.1 ft³/lb) to about 1.4 dl/g (2.2 ft³/lb) and the nitrogen-containing SSP reactor effluent.

Overall aspects of the invention are directed to methods for providing partially crystallized polyester resin to a solid-state polymerization (SSP) reactor and the use of such partially crystallized polyester resin in SSP processes to obtain higher grade polyester products including bottle grade PET. The integration of underwater melt cutting and nitrogen purification into the processes is beneficial for the reasons discussed above. In view of the present disclosure, it will be seen that several advantages may be achieved and other advantageous results may be obtained. Numerous other embodiments will be apparent to those having skill in the art and knowledge gained from the present disclosure, and it will be appreciated that these embodiments do not depart from the scope of the present disclosure.

The following examples are set forth as representative of the present invention. These examples are not to be construed as limiting the scope of the invention as this and other equivalent embodiments will be apparent in view of the present disclosure and appended claims.

### Example 1

Amorphous polyethylene terephthalate (PET), obtained from melt-phase polymerization (MPP) product, was subjected to underwater melt cutting. Three different target sizes (13 mg, 16 mg, and 19 mg) were produced using four different water temperatures for contacting with the MPP product. The underwater cut pellets, in the form of rounded (egg-shaped) chips with no hard edges, were quenched and conveyed to a drier in seconds. After exiting a drier, the chips were stored in an insulated vessel for several minutes to allow crystallinity to increase to the desired degree, so that the chips could be easily transported by hot conveying. After conveying, the chips were white and non-sticky. The size control of the chips was very good at each of the target weights produced.

As a result of the underwater melt cutting, the pellets were produced with a rounded shape and polished surface that resulted in reduced contact area for adhesion. This translated to less attrition and dust formation, as verified in “shaker” attrition tests, compared to cylindrical cut pellets made conventionally in MPP product strand cutting operations. Furthermore, since the pellets from underwater melt cutting were already significantly crystallized, in this case having 42-45% crystallinity, the heat of crystallization in the subsequent SSP reactor would be correspondingly decreased.

### Example 2

The partially crystallized PET resin samples, made in Example 1 with various chip sizes using underwater melt cutting, were tested for reactivity and acetaldehyde formation in an SSP reactor. The reactor was operated under gravity feed of the solid, partially crystallized PET resin chips, with countercurrent nitrogen flow. SSP reactor temperatures of 205° C. (401° F.), 210° C. (410° F.), and 215° C. (419° F.) were studied, and under all conditions the concentration of acetaldehyde in the SSP reactor effluent could be maintained at less than 1 ppm under normal flow rates of nitrogen through the SSP reactor. The partially crystallized PET resin made using underwater melt cutting therefore exhibited very favorable properties, in terms of attrition resistance/dust formation, as well as low acetaldehyde formation and good reactivity in the SSP reactor.

1. A method for providing partially crystallized polyester resin to a solid-state polymerization (SSP) reactor, the method comprising:
(a) contacting a molten, melt-phase polymerization (MPP) product with an aqueous liquid;
(b) cutting the MPP resin product, while submerged in the aqueous liquid, into pellets;
(c) separating dried pellets, formed from the MPP product, from the aqueous liquid in a drying zone; and
(d) contacting the dried pellets with at least a portion of a feed gas comprising a nitrogen-containing effluent gas from the SSP reactor, optionally after removal of organic compounds from the nitrogen-containing effluent,
to provide the partially crystallized polyester resin.

2. The method of claim 1, wherein at least a portion of the aqueous liquid separated in step (c) is recycled and contacted with the molten MPP product in step (a).

3. The method of claim 1, wherein the partially crystallized polyester resin is provided in steps (a)-(d) without mechanical agitators.

4. The method of claim 1, wherein step (d) comprises contacting the dried pellets, from the drying zone in step (c), in stripping and preheating zones with feed gases to each zone, wherein a stripping zone feed gas and a preheating zone feed gas each comprise at least a portion of a nitrogen-containing effluent gas from the SSP reactor, optionally after removal of organic compounds from the nitrogen-containing effluent gas.

5. The method of claim 4, wherein step (d) comprises
(d1) contacting the dried pellets in the stripping zone with a stripping zone feed gas comprising a first portion of a nitrogen-containing effluent gas from the SSP reactor after removing organic compounds, to provide a stripping zone effluent gas; and
(d2) contacting the dried pellets from the stripping zone in (d1) with a preheating zone feed gas comprising a second portion of the nitrogen-containing effluent gas from the SSP reactor, to fluidize the dried pellets in the preheating zone and provide a preheating zone effluent gas.

6. The method of claim 5, wherein, in step (d1), catalytic combustion removes the organic compounds from the first portion of the nitrogen-containing effluent gas from the SSP reactor, which contacts the dried pellets in the stripping zone.

7. The method of claim 6, wherein, in step (d1), catalytic combustion and drying remove both the organic compounds and water from the first portion of the nitrogen-containing effluent gas from the SSP reactor, which contacts the dried pellets in the stripping zone.

8. The method of claim 5, wherein the polyester resin is selected from the group consisting of polyethylene terephthalate (PET), polytrimethylene terephthalate (PTT), polybutylene terephthalate (PBT), polytrimethylene naphthalate (PTN), polycyclohexyl terephthalate (PCT) and polyethylene naphthalate (PEN).

9. The method of claim 8, wherein the polyester resin is PET.

10. The method of claim 9, wherein the dried pellets, from the drying zone in step (c), have an average temperature from about 160° C. (320° F.) to about 210° C. (410° F.) upon contacting with the stripping zone feed gas, having a temperature from about 200° C. (392° F.) to about 235° C. (455° F.).

11. The method of claim 9, wherein, in step (d2), the preheating zone feed gas has a temperature from about 200° C. (392° F.) to about 235° C. (455° F.) upon contacting with the dried pellets from the stripping zone in step (d1).

12. The method of claim 9, wherein the stripping zone effluent gas and the preheating zone effluent gas comprise acetaldehyde.

13. The method of claim 9, wherein the molten MPP product, prior to contact with the aqueous liquid in step (a), has an average crystallinity of less than about 10%.

14. The method of claim 9, wherein the molten MPP product, prior to contact with the aqueous liquid in step (a), has an intrinsic viscosity (IV) from about 0.5 dl/g to about 0.70 dl/g (1.1 ft³/lb).

15. The method of claim 9, wherein the partially crystallized polyester resin has an average crystallinity of at least about 35%.

16. The method of claim 9, wherein the aqueous liquid has a temperature from about 60° C. (140° F.) to about 90° C. (194° F.) and the molten MPP product has a temperature from about 230° C. (446° F.) to about 290° C. (554° F.) upon contacting in step (a).

17. The method of claim 9, wherein the partially crystallized polyester resin is provided in the form of spherical or oval-shaped pellets having a maximum dimension from about 1 mm to about 5 mm and a bulk density from about 0.8 g/cc to about 0.9 g/cc.

18. A solid-state polymerization (SSP) process comprising:
providing the partially crystallized polyester resin, according to the method of claim 1, at a temperature from about 160° C. (320° F.) to about 215° C. (419° F.) and with an average crystallinity of at least about 35%, and
flowing the partially crystallized polyester resin downwardly to contact it countercurrently with upwardly flowing nitrogen carrier gas in an SSP reactor to provide a polyester product and the nitrogen-containing effluent from the SSP reactor.

19. The process of claim 18, wherein the polyester product has an IV from about 0.70 dl/g (1.1 ft³/lb) to about 1.4 dl/g (2.2 ft³/lb).

20. A solid-state polymerization (SSP) process comprising:
(a) contacting a molten, melt-phase polymerization (MPP) product comprising polyethylene terephthalate (PET) having a crystallinity of less than about 10% with an aqueous liquid,
wherein the molten MPP product has a temperature from about 230° C. (446° F.) to about 290° C. (554° F.) and the aqueous liquid has a temperature from about 60° C. (140° F.) to about 90° C. (194° F.) upon contacting;
(b) cutting the MPP product, while submerged in the aqueous liquid, to form pellets;
(c) separating dried pellets, formed from the MPP product, from the aqueous liquid in a drying zone and recycling a least a portion of the aqueous liquid to contact it with the molten MPP in step (a);
(d) contacting the dried pellets from the drying zone, in a stripping zone with a first portion of a nitrogen-containing effluent gas from an SSP reactor after removing organic compounds by combustion, to provide a stripping zone effluent gas,
wherein the dried pellets have an average temperature from about 160° C. (320° F.) to about 215° C. (419° F.) and the first portion of the nitrogen-containing effluent gas has a temperature from about 200° C. (392° F.) to about 235° C. (455° F.) upon contacting the dried pellets with the first portion of the nitrogen-containing effluent gas in the stripping zone;
(e) contacting the dried pellets from the stripping zone, in a preheating zone with a second portion of the nitrogen-containing effluent gas from the SSP reactor, to provide a preheating zone effluent gas and a partially crystallized polyester resin having an average crystallinity of at least about 35%,
wherein the second portion of the nitrogen-containing effluent has a temperature from about 200° C. (392° F.) to about 235° C. (455° F.) upon contacting it with the dried pellets in the preheating zone; and
(f) flowing the partially crystallized polyester resin downwardly to contact it countercurrently, at an initial contacting temperature from about 160° C. (320° F.) to about 215° C. (419° F.), with upwardly flowing nitrogen carrier gas in the SSP reactor to provide a polyester product having an IV from about 0.70 dl/g (1.1 ft³/lb) to about 1.4 dl/g (2.2 ft³/lb) and the nitrogen-containing SSP reactor effluent.
